(19) United States
(12) Patent Application Publication
(10) Pub. No.: US 2025/0094907 A1
(43) Pub. Date: Mar. 20, 2025

(54) SOFTWARE APPLICATION ENABLED SYSTEM AND METHOD FOR INCORPORATION AND CORPORATE MANAGEMENT

(71) Applicant: Incorporight Inc., Toronto (CA)

(72) Inventor: Tyler Benoliel, Toronto (CA)

(21) Appl. No.: 18/470,511

(22) Filed: Sep. 20, 2023

(51) Int. Cl. G06Q 10/0637

(52) U.S. Cl. CPC G06Q 10/0637

(57) ABSTRACT

A method for incorporating a business and managing a corporation, including: receiving, by a system, inputs designating a business location, a proposed corporation name, and details of a user and corporation; transmitting, by the system, corporation details to a third-party authority; generating, by the system, corporate organizational documents; updating, by the system, a profile account of the business; receiving, by the system, input designating a signature on the corporate organizational documents; updating, by the system, a ledger based on data received and generated by the system using a blockchain framework; storing, by the system, the data on a blockchain network; monitoring, by the system, the ledger using the blockchain framework; controlling, by the system, user access to parts of the system using the blockchain framework; and managing, by the system, a corporation and corresponding ledger using dashboard, minute book, signing room, filings, company changes, activity log, and settings modules.

### FIELD OF THE DISCLOSURE

This disclosure relates to business incorporation and corporate management in general, and more particularly, to a software application for incorporation and corporate management that implements blockchain technology to enhance reliability, security, and efficiency.

### BACKGROUND

The incorporation and management of corporate entities have traditionally been time-consuming and complex processes, involving multiple intermediaries, redundant paperwork, and the need for centralized trust. Existing software tools for corporate management often lack transparency and may be susceptible to data tampering or unauthorized alterations.

The present invention aims to address these challenges by providing a secure, efficient, and transparent incorporation and corporate management software application by leveraging the benefits of blockchain technology.

### SUMMARY

The following presents a simplified summary of some embodiments of the techniques described herein in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Embodiments include a method for incorporating a business, including: receiving, by a system for incorporating a business, via a user interface of a software application of a communication device, at least one first input designating a business location; receiving, by the system, via the user interface of the software application, at least one second input designating a proposed corporation name; receiving, by the system, via the user interface of the software application, at least one third input designating personal details of a user, an industry, and sole owner and operator or joint owners or operators, wherein upon designating joint owners or operators, the at least one third input further comprises owner information of each owner, ownership stake of each owner, and operator information of each operator; transmitting, by the system or an administrator, at least one of the personal details of the user, the industry, the owner information of each owner, the ownership stake of each owner, and the operator information of each operator to a third-party authority; generating, by the system, via the software application, corporate organizational documents based on at least one of the at least first input, the at least second input, and the at least third input; updating, by the system, at least a profile account of the business based on at least one of the at least first input, the at least second input, the at least third input, and at least one of the corporate organizational documents; receiving, by the system, via the user interface of the software application, at least one fourth input designating a signature on at least one of the corporate organizational documents; updating, by the system, via the software application, an auditable and unalterable ledger based on at least some data received and data generated by the system using a blockchain framework integrated within the system; storing, by the system, via the software application, at least some of the data received and the data generated by the system on a blockchain network using the blockchain framework integrated within the system; monitoring, by the system, via the software application, the ledger using the blockchain framework integrated within the system; and controlling, by the system, via the software application, user access to parts of the system using the blockchain framework integrated within the system; wherein the software application comprises program code configured to execute operations of the system.

Further aspects of the method include: determining, by the system, via the software application, whether there are any conflicts between the proposed corporation name and existing corporation names and whether the proposed corporation name is inappropriate or improper according to applicable legislation; and displaying, by the system, via the user interface of the software application, a notification relating to the proposed corporation name, wherein the possible notifications include a notification that the proposed corporation name satisfies a preliminary name check, is similar to one or more existing corporation names, is an exact match to an existing corporation name, and is inappropriate or improper according to applicable legislation.

Further aspects of the method include: generating, by the system, a confirmation of incorporation details form based on the at least one first input, the at least one second input, and the at least one third input; displaying, by the system, via the user interface of the software application, the confirmation of incorporation details form; and receiving, by the system, via the user interface of the software application, at least one fifth input designating a confirmation of the incorporation details displayed.

Further aspects of the method include: managing, by the system, via the software application, the corporation using a corporate summary dashboard module, a minute book module, a signing room module, a filings module, a company changes module, an activity log module, and a settings module. Further aspects of the method include: displaying, by the system, within the corporate summary dashboard module of the system, via the user interface of the software application, company information, shareholder information, director information, and officer information; displaying, by the system, within the minute book module of the system, via the user interface of the software application, the corporate organizational documents; receiving, by the system, within the minute book module of the system, via the user interface of the software application, at least one sixth input designating an instruction to download a document within the minute book module and an instruction to add a new document to the minute book module; displaying, by the system, within the signing module of the system, via the user interface of the software application, a name of documents requiring review or signature, a status of each document, and the documents requiring review or signature, wherein the at least one fourth input designating the signature on at least one of the corporation documents is received within the signing module of the system, via the user interface of the software application; displaying, by the system, within the filings module, via the user interface of the software application, at least one corporate annual return, a state of each corporate annual return, and a due date of each corporate annual return; receiving, by the system, within the filings module, via the user interface of the software application, at least one seventh input designating an instruction to start a corporate annual return, upon which, the system receives, within the filings module, via the user interface of the software application, at least one eighth user input designating a confirmation of completion of shareholders meetings for the fiscal year end, a date of the meeting, a confirmation of directors and officers, and a confirmation of corporation contact information; generating, by the system, within the filings module, via the software application, an annual resolution based on at least one of the at least one eighth input and information stored in a database; filing, by the system, within the filings module, via the software application, at least one of the corporation documents or another document with an external third party authority; obtaining, by the system, within the filings module, via the software application, a document from the external third party authority; receiving, by the system, within the company changes module, via the user interface of the software application, at least one ninth input designating a new director, a modification to existing director information, or a removal of an existing director; a new share issuance, a modification to existing shareholder information, or a transfer or redemption of shares of an existing shareholder; and a new officer, a modification to existing officer information, or a removal of an existing officer; displaying, by the system, within the activity logs module, via the user interface of the software application, a list of all actions performed relating to the corporation and a blockchain transaction ID corresponding to each action; and receiving, by the system, within the settings module, via the user interface of the software application, at least one tenth input designating a modification to billing information; and management of users comprising adding a new user, a modification to an existing user, or a deletion of an existing user and assigning a role and access level.

Further aspects of the method include: receiving, by the system, via the user interface of the software application, at least one eleventh input designating an instruction to begin an incorporation process. Further aspects of the method include: displaying, by the system, via the user interface of the software application, a location within a map corresponding with the business location. In further aspects of the method the at least one third input further comprises a payment plan and billing and payment information. In further aspects of the method the blockchain framework supports smart contracts to automate and execute predefined actions comprising at least one of dividend distributions, voting procedures, compliance tracking, and automated contract performance based on predefined rules.

Further aspects of the method include: receiving, by the system, via the user interface of the software application, at least one twelfth input designating a class of shares, priority rights of the shares, non-voting or voting rights of the shares, unlimited or limited shares, a number of authorized shares, a redeemable condition of the shares, a retractable condition of the shares, and dividend rights of the shares. In further aspects of the method the system is configured to manage a plurality of corporations using a single user account. Further aspects of the method include: receiving, by the system, via the user interface of the software application, at least one thirteenth input designating a corporation from the plurality of corporations to manage using the system.

Embodiments provide a non-transitory, machine-readable media storing program code of a software application that when executed by a processor effectuates system operations as described in the method above.

Embodiments provide a method for managing a corporation, including: managing, by a system, via a software application, the corporation using a corporate summary dashboard module, a minute book module, a signing room module, a filings module, a company changes module, an activity log module, and a settings module; displaying, by the system, within the corporate summary dashboard module of the system, via the user interface of the software application, company information, shareholder information, director information, and officer information; displaying, by the system, within the minute book module of the system, via the user interface of the software application, corporate records; receiving, by the system, within the minute book module of the system, via the user interface of the software application, at least one first input designating an instruction to download a document within the minute book module and an instruction to add a new document to the minute book module; displaying, by the system, within the signing module of the system, via the user interface of the software application, a name of documents requiring review or signature, a status of each document, and the documents requiring review or signature; receiving, by the system, within the signing module of the system, via the user interface of the software application, at least one second input designating a signature on at least one document; displaying, by the system, within the filings module, via the user interface of the software application, at least one corporate annual return, a state of each corporate annual return, and a due date of each corporate annual return; receiving, by the system, within the filings module, via the user interface of the software application at least one third input designating an instruction to start a corporate annual return, upon which, the system receives, within the filings module, via the user interface of the software application at least one fourth user input designating a confirmation of completion of shareholders meetings for the fiscal year end, a date of the meeting, a confirmation of directors and officers, and a confirmation of corporation contact information; generating, by the system, within the filings module, via the software application, an annual resolution based on at least one of the at least one fourth input and information stored in a database; filing, by the system, within the filings module, via the software application, at least one document with an external third party authority; obtaining, by the system, within the filings module, via the software application, a document from the external third party authority; receiving, by the system, within the company changes module, via the user interface of the software application, at least one fifth input designating a new director, a modification to existing director information, or a removal of an existing director; a new share issuance, a modification to existing shareholder information, or a transfer or redemption of shares of an existing shareholder; and a new officer, a modification to existing officer information, or a removal of an existing officer; displaying, by the system, within the activity logs module, via the user interface of the software application, a list of all actions performed relating to the corporation and a blockchain transaction ID corresponding to each action; receiving, by the system, within the settings module, via the user interface of the software application, at least one sixth input designating a modification to billing information; and management of users comprising adding a new user, a modification to an existing user, or a deletion of an existing user and assigning a role and access level; updating, by the system, via the software application, an auditable and unalterable ledger based on at least some data received and data generated by the system using a blockchain framework integrated within the system; storing, by the system, via the software application, at least some of the data received and the data generated by the system on a blockchain network using the blockchain framework integrated within the system; monitoring, by the system, via the software application, the ledger using the blockchain framework integrated within the system; and controlling, by the system, via the software application, user access to parts of the system using the blockchain framework integrated within the system.

### BRIEF DESCRIPTION OF THE FIGURES

FIG. 1 illustrates a landing page of a software application from which a user may begin an incorporation process.

FIG. 2 illustrates a login page of the software application.

FIG. 3 illustrates a business address and a map pointing to the business address displayed by the user interface of the software application.

FIGS. 4A-4D illustrate a proposed corporation name and notifications associated with the proposed corporation name displayed by the user interface of the software application.

FIG. 5 illustrates user information displayed by the user interface of the software application.

FIG. 6 illustrates corporate information fields displayed by the user interface of the software application.

FIGS. 7A-7C illustrate shareholder and share information displayed by the user interface of the software application.

FIGS. 8A-8C illustrate operator information displayed by the user interface of the software application.

FIG. 9 illustrates subscription plans available.

FIG. 10 illustrates billing and payment information displayed by the user interface of the software application.

FIG. 11 illustrates a confirmation of incorporation details form generated by the system.

FIG. 12 illustrates an email generated by the system notifying a user of documents ready for signing.

FIGS. 13A-13D illustrate a dashboard module of the system.

FIG. 14 illustrates a minute book module of the system.

FIGS. 15A-15C illustrate a signing room module of the system.

FIGS. 16A-16F illustrate a filing room module of the system.

FIGS. 17A-17H illustrate a company changes module of the system.

FIG. 18 illustrates an activity module of the system.

FIGS. 19A and 19B illustrate a settings module of the system.

FIG. 20 illustrates a Hyperledger Fabric blockchain diagram.

FIG. 21 illustrates a flowchart for a process for incorporation.

FIG. 22 illustrates modules of the system used for corporate management of a corporation.

FIG. 23 illustrates an example of the user interface of the software application executed by a communication device.

### DETAILED DESCRIPTION OF SOME EMBODIMENTS

The present inventions will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well known process steps and/or structures have not been described in detail in order to not unnecessarily obscure the present invention. Further, it should be emphasized that several inventive techniques are described, and embodiments are not limited to systems implanting all of those techniques, as various cost and engineering trade-offs may warrant systems that only afford a subset of the benefits described herein or that will be apparent to one of ordinary skill in the art.

The present invention discloses a novel and innovative system and method that leverages the benefits of blockchain technology for streamlined incorporation and efficient corporate management. In embodiments, the system and method for incorporation and corporate management are executed using a software application, such as a web-based or downloadable application executed on a communication device (e.g., mobile phone, tablet, etc.). By harnessing the power of blockchain technology, the system and method for incorporation and corporate management provides transparency, security, and data immutability, revolutionizing the way businesses incorporate and govern themselves.

Embodiments include a system and method for creating and managing a corporation using the software application executed on the communication device. In embodiments, the system is configured to receive at least one input via a user interface of the software application designating at least one of an instruction to begin the incorporation process for a business and an address of the business. Upon receiving the input designating the business address, the system is configured to display via the user interface of the software application the business location on a map. In embodiments, the system is configured to receive at least one input via the user interface of the software application designating a proposed corporation name of the business. The system is configured to search existing corporate names, identify improper or inappropriate corporate names (e.g., a corporate name including a curse word), determine whether there are any conflicts between the proposed corporate name and existing corporate names or whether the proposed corporate name includes a word requiring regulatory approval, and display, via the user interface of the software application, a notification relating to the corporate name (e.g., a notification that the proposed corporate name satisfies a preliminary name check, is similar to one or more existing corporate names, is an exact match to an existing corporate name, is improper or inappropriate, and includes a word requiring regulatory approval). In embodiments, the system is configured to receive at least one input via the user interface of the software application designating a legal ending of the business (e.g., Inc., Ltd., Corp.), personal details of a user (e.g., name, address, email, password), and corporate information. The corporate information may include a designation of corporation type (e.g., federal or provincial or other corporation types), address, industry, accounting year end, sole owner/operator or joint owners/operators, a payment plan (e.g., basic or plus), and billing and payment information (e.g., name, address, credit card information). In the case of joint owners/operators, the system is configured to request additional input designating owner information (e.g., name and address) and ownership stake (e.g., shares and share class) of each owner and operator information of each director and officer (e.g., name, address, title such as president, secretary, director, etc.). Using the inputs received via the user interface of the software application, the system is configured to generate and display, via the user interface, a confirmation of incorporation details form. In some embodiments, the system requires a payment prior to generating the confirmation of incorporation details form. In some embodiments, the system is configured to receive at least one input via the user interface of the software application confirming the incorporation details included in the form. In embodiments, the system is configured to transmit the application for incorporation to a government body for approval and update a profile of the organization within the software application and corporate-specific information stored in a database upon approval. In embodiments, using the inputs received via the user interface of the software application and form templates, the system is configured to generate corporate organizational documents (e.g., By-Laws, Initial Director and Shareholder Resolutions, Consents to Act as Director, Subscriptions for Shares, Notices of Issuance of Uncertificated Securities, and/or other corporate organizational documents depending on the jurisdiction of incorporation). In embodiments, the system is configured to generate and transmit one or more emails to the user notifying the user of incorporation of their business and providing a summary of next steps, the subscription plan chosen, and corporate organizational documents required for signature. In some embodiments, a link within one of the generated emails or the user interface of the software application is used to navigate to a signing room module of the system to review, accept and/or electronically sign the documents.

In some embodiments, the province, country, industry type, fiscal year end, and designated officer titles, may be chosen from a list of preselected options using the user interface of the software application.

In some embodiments, the system provides advanced options for share classes for the corporation, wherein class type (common, preferred, special), class name (A, B, C, etc. or custom), priority rights, voting rights, number of shares authorized, redeemability, retractability, and dividend rights may be chosen from a list of preselected options using the user interface of the software application. In embodiments, corporate-specific information is stored in the database and used by the system during execution of future operations for management of the corporation.

In embodiments, the system comprises a corporate summary dashboard module, a minute book module, a signing room module, a filings module, a company changes module, an activity logs module, and a settings module for corporate management of a corporation. The software application is configured to receive at least one input designating an instruction to view a module from the plurality of modules, upon which the software application is configured to display the module.

The dashboard module provides an overview of essential corporate information. The system is configured to receive at least one input via the user interface of the software application designating an instruction to view general information, upon which the system is configured to display, via the user interface, company information (e.g., date of incorporation, business number, corporation number, jurisdiction, and fiscal year end) and a shareholder chart. The system is configured to receive at least one input via the user interface of the software application designating an instruction to view shareholders, upon which the system is configured to display, via the user interface, shareholder information (e.g., number of current shareholders and number of current share classes) and a shareholder chart. In some embodiments, shareholder information, such as name, class, ownership, and issuance date, and share information, such as share class name, voting, and creation date, may be displayed. The system is configured to receive at least one input via the user interface of the software application designating an instruction to view directors, upon which the system is configured to display, via the user interface, director information (e.g., minimum number of directors, maximum number of directors, current directors, and board seats available) and a shareholder chart. In some embodiments, current director information, such as director name and elected date, may be displayed.

The minute book module allows users to maintain and organize corporate meeting minutes, resolutions, and other official records, securely facilitating easy access and retrieval of historical documents. The system is configured to display, via the user interface, at least one corporate organizational document upon receiving input designating an instruction to view any of the above-listed documents. The system is configured to receive at least one input via the user interface of the software application designating an instruction to download a document within the minute book and an instruction to add a new document to the minute book, upon which the system is configured to download the document and add the new document to the minute book, respectively.

The signing room module offers a secure and convenient platform for digitally signing documents, contracts, and agreements, ensuring a legally binding process. Within the signing room, digital documents are reviewed, accepted, and signed with a signature created using the user interface of the software application. The system is configured to display, via the user interface of the software application, documents requiring review/signature and a status of each document (e.g., pending or signed). The system is configured to receive at least one input via the user interface of the software application designating an acceptance of a document and a signature for a document.

The filings module enables users to manage and submit legal and regulatory documents to relevant authorities, streamlining compliance processes. The system is configured to communicate with an external third-party authority (e.g., Corporations Canada, Ontario Business Registry, or other external third-party authorities) to submit and obtain legal and regulatory documents to and from the external third-party authority, respectively. Within the filings module, the system is configured to display one or more corporate annual returns (e.g., federal and provincial), the state of each corporate annual return (complete or incomplete), and a due date of each corporate annual return. The system is configured to receive at least one input via the user interface of the software application designating an instruction to start a corporate annual return, upon which, the system requests at least one user input via the user interface designating information required to complete a corporate annual return (e.g. a confirmation of completion of shareholders meetings for the previous fiscal year, a date of the meeting, a confirmation of the directors and officers, and a confirmation of corporation contact information). In embodiments, the system is configured to generate an annual shareholder resolution that may be signed by users via the signing room module. The system may be configured to autonomously transmit the corporate annual return or the corporate annual return may be manually transmitted by a user to a government body. In embodiments, the system updates the activity logs module and the blockchain to include the actions associated with the corporate annual return, wherein a corresponding blockchain transaction ID is provided for each action within the activity logs module. In embodiments, documents associated with the corporate annual return are stored in the minute book module.

The company changes module allows users to manage updates to corporate information. The system is configured to receive an input via the user interface of the software application designating an instruction to view directors, upon which the system is configured to display, via the user interface, a list of directors, their appointment date, and personal information. Users have the option to add/remove directors by providing as input to the user interface of the software application personal information of the new director (e.g., name, email, phone number, and address) or a selection of an existing personal profile stored within the system. An addition, modification, or removal of a director may be executed by the system once payment is provided for execution of the update and the requisite corporate resolution among other documents (e.g. Consent to Act as Director, Director Resignation, etc.) are signed accordingly using the signing module user interface. The system is configured to receive an input via the user interface of the software application designating an instruction to view shareholders, upon which the system is configured to display, via the user interface, a list of shareholders, share class, and personal information. Users have the option to add/remove shareholders by providing as input to the user interface of the software application personal or company information of the new shareholder (e.g., name, email, phone number, address, company representative) or a selection of an existing personal profile stored within the system and share class and number of shares for the newly added shareholder. An addition, modification, or deletion of a shareholder may be executed by the system once payment is provided for execution of the update and the requisite corporate resolution among other documents (e.g. Subscription for Shares, Share Purchase Agreement, Redemption Agreement, Notice of Issuance of Uncertificated Securities, etc.) are signed accordingly using the signing module user interface. The system is configured to receive an input via the user interface of the software application designating an instruction to view officers, upon which the system is configured to display, via the user interface, a list of officers, their appointment date, and personal information. Users have the option to add/remove officers and change operator titles by providing as input to the user interface of the software application personal information of the new operator (e.g., name, email, phone number, and address) or a selection of an existing personal profile stored within the system. An addition, modification, or deletion of an operator may be executed by the system once payment is provided for execution of the update and the requisite corporate resolution among other documents are signed accordingly using the signing module user interface. The system is configured to receive an input via the user interface of the software application designating an instruction to view contact information, upon which the system is configured to display, via the user interface, the corporation's registered contact information (e.g., address). Users can choose to update the corporation's registered contact information by providing as input to the user interface of the software application the required contact information. Updating the contact information may be executed by the system once payment is provided for execution of the update and the requisite documentation among other documents are signed accordingly using the signing module user interface. In embodiments, corporate-specific information stored in the database is updated according to any changes executed. The updated corporate-specific information is used by the system during execution of future operations for management of the corporation.

The activity logs module maintains a comprehensive record of all actions performed within the system, providing an audit trail for transparency and accountability. Within the activity logs module, the system is configured to display, via the user interface of the software application, a list (e.g., action name, action taken, date, and time) of each action performed and a corresponding blockchain transaction ID for each action.

The settings module allows users to customize the system according to their specific corporate requirements, ensuring flexibility and adaptability. The system is configured to display, via the user interface of the software application, billing information and user information. The system is configured to receive at least one input via the user interface of the software application designating an instruction to view or update billing information (e.g., name, address, subscription plan, and payment information) and user information (e.g., access type, role type, name, and address), modified billing information, an addition or deletion of a user, and new user information (e.g., access type, role type, name, and address). Access types may include full access and view only and role types may include legal, accounting, director/officer, and employee/contractor.

In embodiments, the system is used to manage more than one company, wherein the system is configured to receive at least one input via the user interface of the software application designating a company from a plurality of companies to manage, an instruction to create (i.e., incorporate) a new company, an item/topic to search within the system, an instruction to view a user profile, an instruction to view notifications, an instruction to change a password, and an instruction to log out of the system. The system is configured to display, via the user interface, the notifications and the user profile. The system is configured to change the password upon providing as input to the user interface of the software application the current password and the new password. In some embodiments, users may be granted full access or view only access to the system.

In embodiments, blockchain technology is integrated within the system to create an auditable and unalterable ledger of critical corporate data (e.g., company details, shareholder information, minute book records, etc.). A blockchain framework, namely Hyperledger Fabric, is integrated within the system. The Hyperledger Fabric provides a fine-grained access control mechanism to ensure that only authorized users can access specific parts of the system. This is achieved using a combination of digital certificates, PKI infrastructure, and access control lists. The Hyperledger Fabric uses strong cryptographic algorithms to ensure the confidentiality and integrity of data at rest and in transit over a network. The Hyperledger Fabric uses a consensus mechanism to ensure that all nodes on the network agree on the current state of the ledger, making the system resistant to attacks and ensuring the validity of transactions. The Hyperledger Fabric supports the execution of smart contracts, which are self-executing programs that automatically enforce the rules and regulations (e.g., rules stipulated in a shareholders agreement). By employing smart contracts, the system automates and executes predefined actions, such as dividend distributions, voting procedures, and compliance tracking, thereby reducing the need for intermediaries and manual interventions. The Hyperledger Fabric provides a secure and private way to store sensitive information as it allows for the storage of private data on the blockchain network, which can be accessed only by authorized users. The Hyperledger Fabric provides auditing and monitoring capabilities to track and trace activities on the blockchain network, allowing for quick detection and response to any security breaches or anomalies in the system.

In some embodiments, the system includes a contract builder with smart contract capability, a corporate resolution builder with smart contract capability, a contract template shop with smart contract capability, an intellectual property filing system with direct integration with government filing systems, a virtual shareholder and director meeting room with participant voting capabilities, an employee management tool with stock rights and smart contract capability, a module for starting and maintaining other business entities (e.g., limited liability companies, limited partnerships, etc.), and a dedicated portal and/or payment plan for lawyers and accountants.

In some embodiments, the system includes an artificial intelligence chatbot that provides legal advice/direction, an integrated machine learning system to manage the system (e.g., starting and maintaining corporations, building agreements, corporate resolutions, and advising users), and a smart contract creation/building tool. In some embodiments, the machine learning system learns to optimize corporate maintenance, contract preparation, product advertisement, etc. In some embodiments, the system is configured to work with quantum computing systems. In some embodiments, the system integrates a blockchain framework with blockchain nodes that are further decentralized from traditional industry sources (e.g., banks, governments, universities, etc.). In some embodiments, the system implements a blockchain framework or configures the existing blockchain framework described herein particularly for tracking and storing intellectual property rights and assets.

In some embodiments, the system integrates with proprietary or third-party financial products (e.g., bank accounts, credit facilities, and private investment vehicles), insurance products (e.g., commercial general liability insurance and related products), payment processing products (e.g., digital and physical payment terminals), accounting and bookkeeping products and services (e.g., bookkeeping, tax filing, etc.), technology products and services (e.g., website builders, software developers, hardware and software products, etc.), and marketing products and services (e.g., online marketing, advertisement services, etc.).

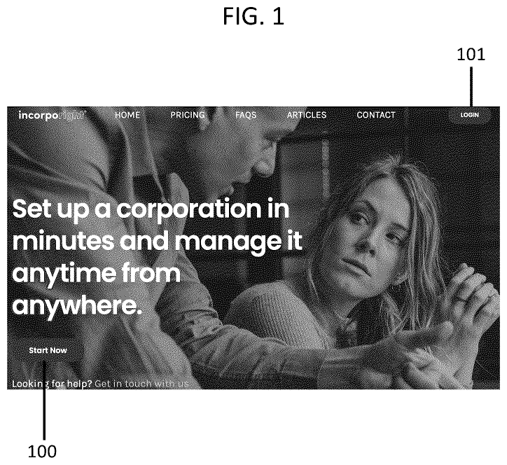

FIG. 1 illustrates an example of a landing page of a software application from which a user may begin an incorporation process 100 or login 101 to start/complete an incorporation process of a business and/or manage a corporation.

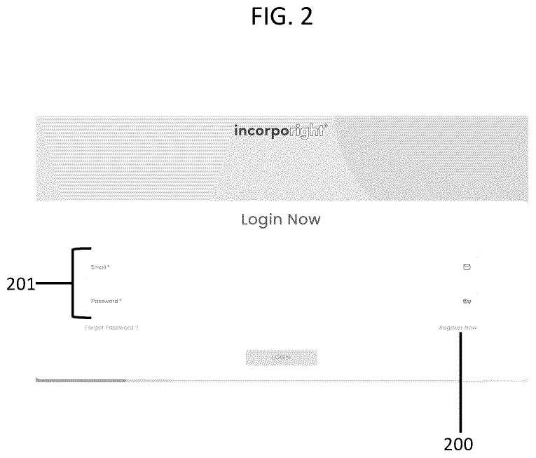

FIG. 2 illustrates an example of a user interface of the software application including methods by which the user provides input to the system designating an instruction to register to start the incorporation process 200 or login information 201 to start/complete the incorporation process of a business and/or manage a corporation.

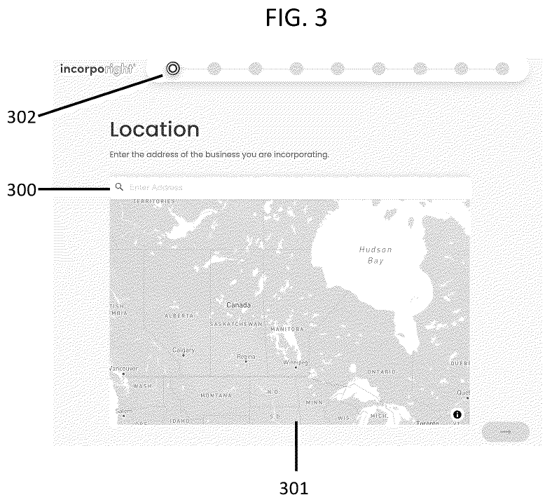

FIG. 3 illustrates an example of a user interface of the software application including a method by which the user provides input to the system designating an address of the business 300 for incorporation, which the system uses in determining a jurisdiction of the corporation. The user interface displays a location of the address on a map 301. A status bar 302 is displayed to show user progress towards completion of the incorporation.

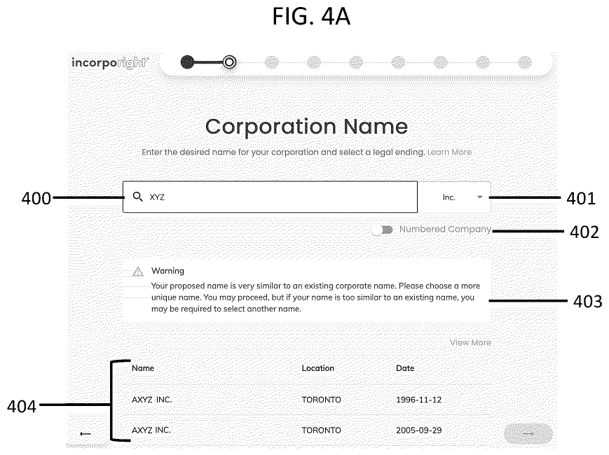

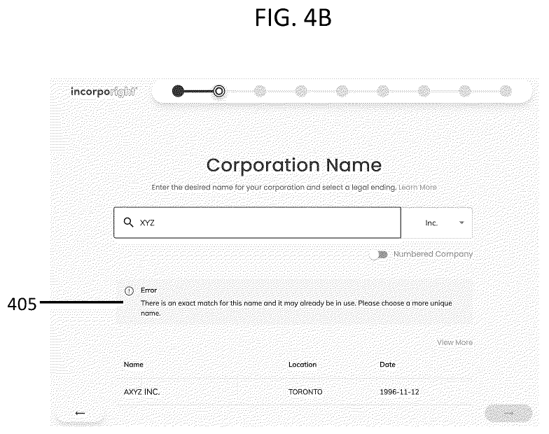

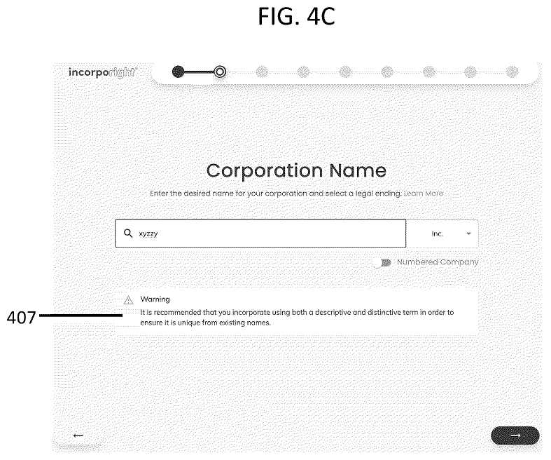

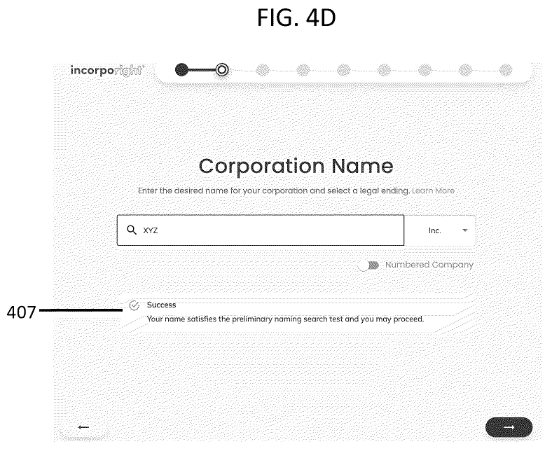

FIG. 4A illustrates an example of a user interface of the software application including methods by which the user provides input to the system designating a proposed corporation name of the business 400, a legal ending for the corporation 401 (e.g., Inc, Ltd., etc.), and the designation of the business as a numbered company 402. The user interface displays a warning 403 if the corporation name proposed is similar to existing corporate names and generate a list 404 of the similar corporate names. FIG. 4B illustrates an example of a warning 405 displayed when the corporate name proposed is the same as an existing corporate name. FIG. 4C illustrates an example of a warning 406 displayed when the corporate name proposed is improper. FIG. 4D illustrates an example of a successful confirmation 407 displayed when the corporate name proposed is unique.

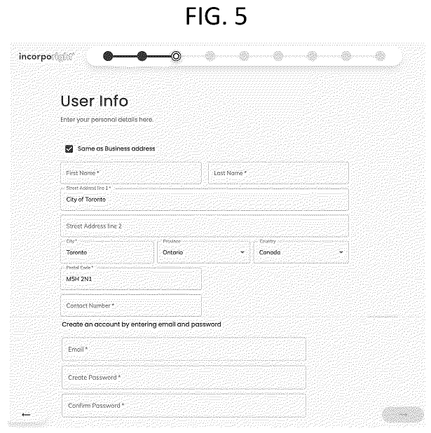

FIG. 5 illustrates an example of a user interface of the software application including methods by which the user provides input to the system designating personal details required for creating an account including name, address, phone number, email, and password.

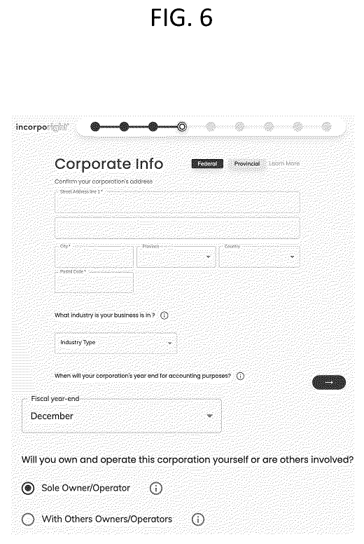

FIG. 6 illustrates an example of a user interface of the software application including methods by which the user provides input to the system designating corporation information including address, corporation type, industry type, fiscal year end, and ownership type.

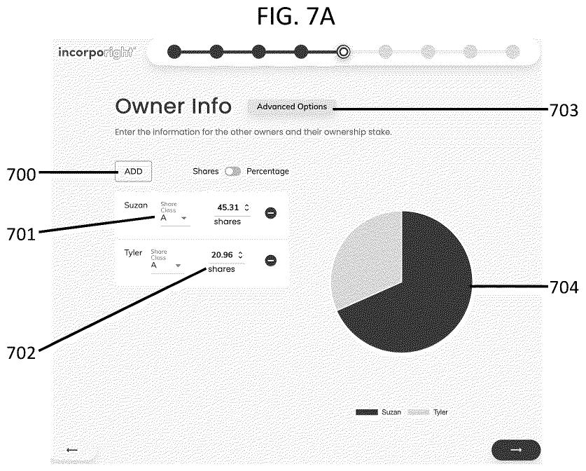

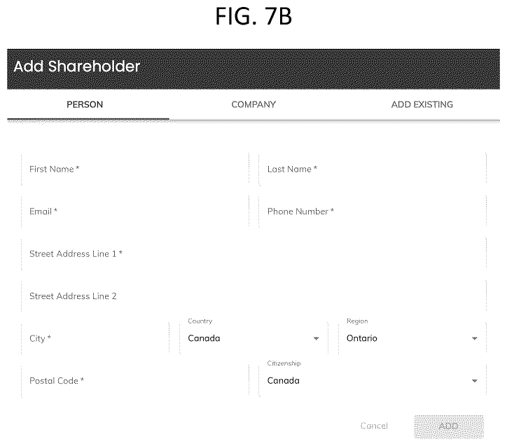

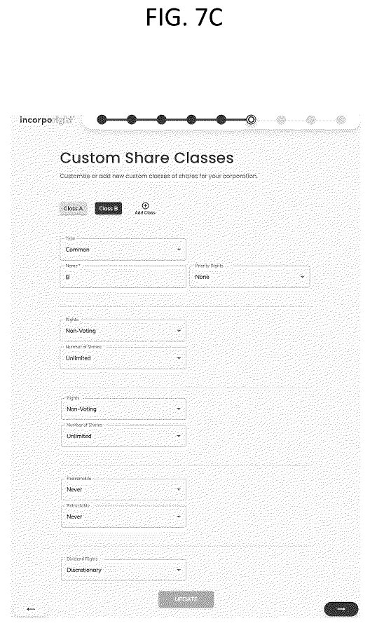

FIG. 7A illustrates an example of a user interface of the software application including methods by which the user provides input to the system designating an instruction to add a new shareholder 700, a modification in owner share class 701, a modification in number of shares for an owner 702, and customized share classes with advanced options 703. The user interface displays the ownership stakes in a pie chart 704. FIG. 7B illustrates an example of a user interface of the software application including methods by which the user provides input to the system designating the new shareholder as a person, company, or existing contact and their name and address, upon providing input designating an instruction to add the new shareholder 700. FIG. 7C illustrates an example of a user interface of the software application upon providing input designating an instruction to add customized share classes through advanced options 703 including class type (common, preferred, special), class name (A, B, C, etc. or custom), priority rights, voting rights, number of shares authorized, redeemability, retractability, and dividend rights may be chosen from a list of preselected options using the user interface of the software application.

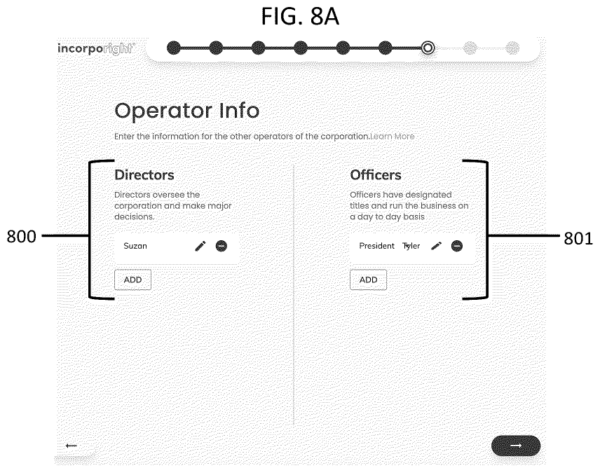

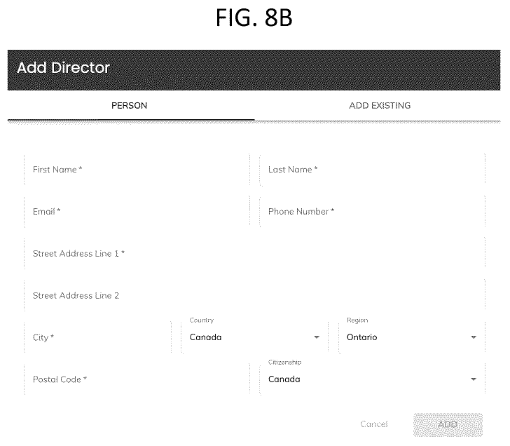

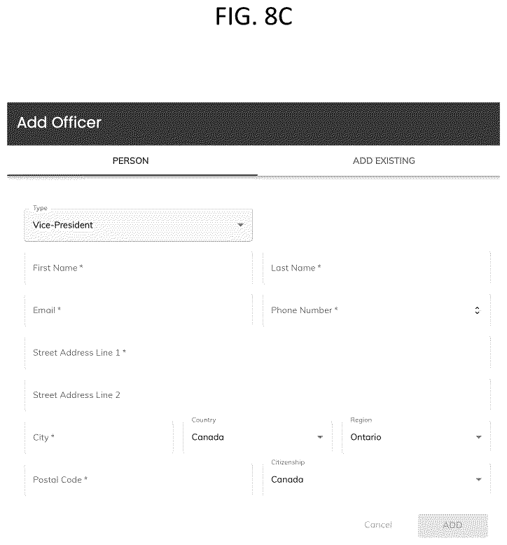

FIG. 8A illustrates an example of a user interface of the software application including methods by which the user provides input to the system designating operator information including the addition, deletion, or modification of directors 800 and officers 801. FIG. 8B illustrates an example of a user interface of the software application including methods by which the user provides input to the system designating director information including name, address, and officer title (if applicable) or as an existing contact, upon providing input designating an instruction to add the new director 800 or officer 801. FIG. 8C illustrates an example of a user interface of the software application including methods by which the user provides input to the system designating officer information including name, address, and title or as an existing contact, upon providing input designating an instruction to add the new officer 801.

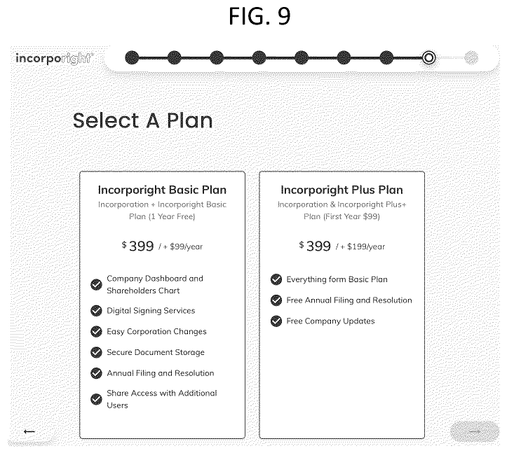

FIG. 9 illustrates an example of a user interface of the software application including methods by which the user provides input to the system designating a basic or plus subscription plan. Other subscription plans may also be possible.

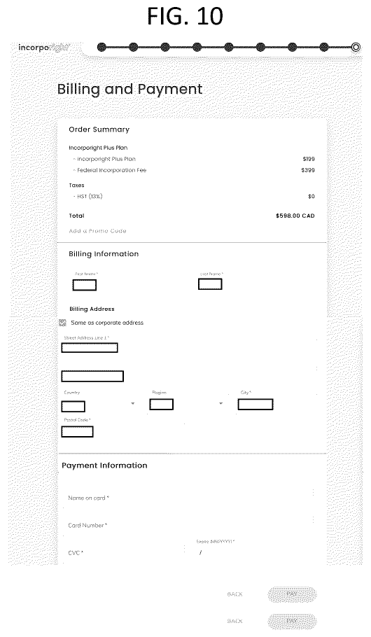

FIG. 10 illustrates an example of a user interface of the software application including methods by which the user provides input to the system designating billing information (e.g., name and address) and payment information (e.g., credit card information). The user interface displays an order summary.

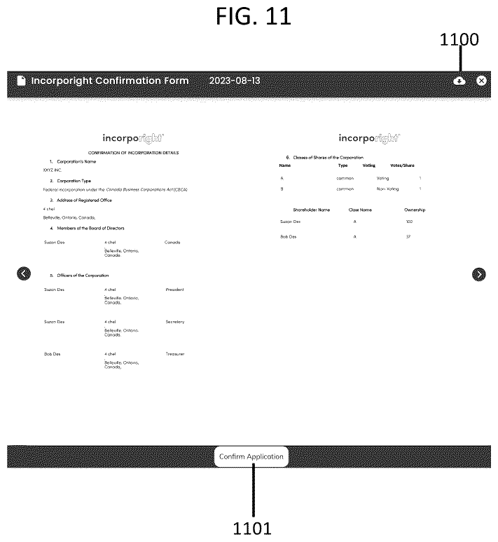

FIG. 11 illustrates an example of a user interface of the software application including methods by which the user provides input to the system designating an instruction to download 1100 incorporation details displayed by the user interface and a confirmation 1101 of the incorporation details.

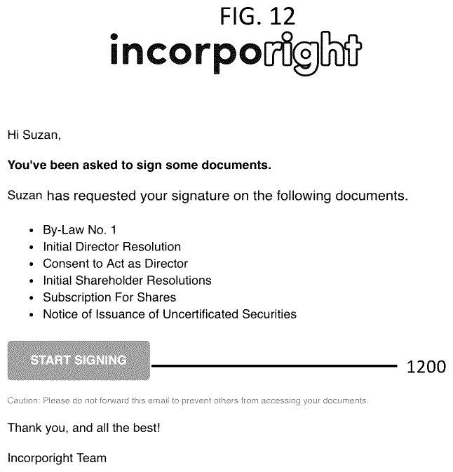

FIG. 12 illustrates an example of an email generated by the system notifying the user that incorporation documents are ready for signing. A link 1200 within the email is used to navigate to a signing room module of the system to review and electronically sign the documents.

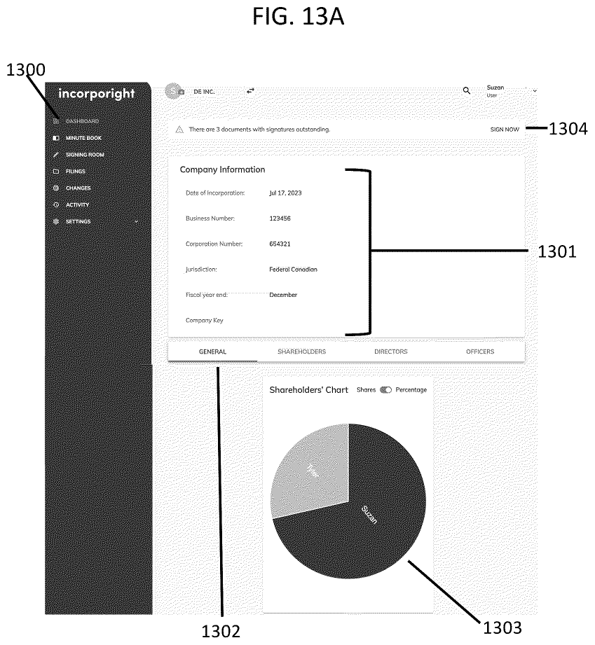

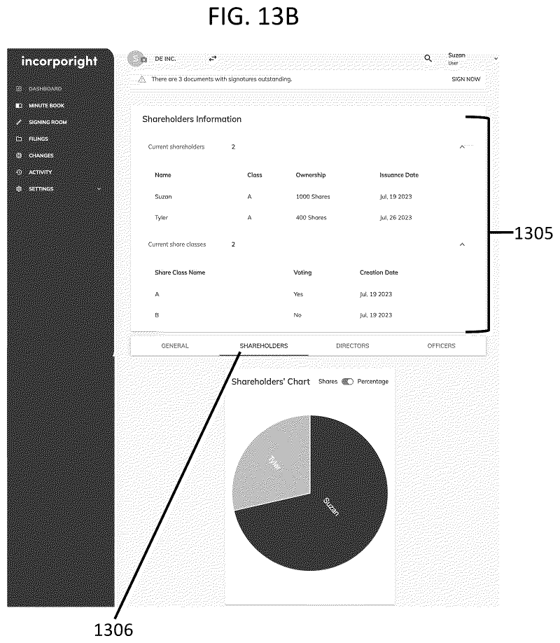

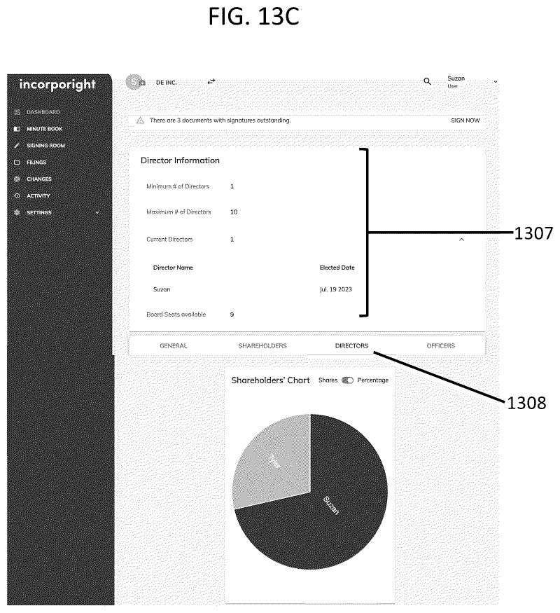

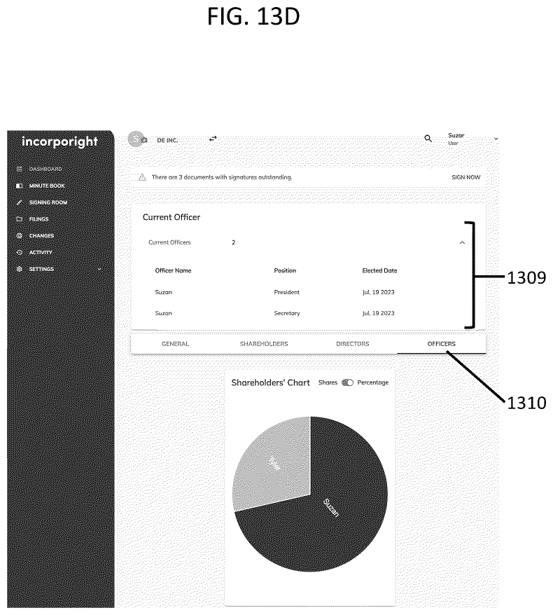

FIG. 13A illustrates an example of a user interface of the software application for a dashboard module 1300 of the system. Within the dashboard module 1300, company information 1301 including date of incorporation, business number, corporation number, jurisdiction, and fiscal year end is displayed upon user selection of a general tab 1302. The company information may vary depending on the jurisdiction of the corporation. A pie chart 1303 of shareholder holdings as a division of number of shares or as a percentage of shares and a notification ribbon 1304 are displayed by the user interface. The notification ribbon 1304 alerts users to any immediate actions to be taken (e.g., documents to sign). In FIG. 13B, shareholder information 1305 including shareholder name, share class, number of shares, issuance date, creation date of a share class and voting capabilities of a share class is displayed by the user interface upon user selection of a shareholder tab 1306. In FIG. 13C, director information 1307 including minimum/maximum number of directors, number of current directors, director name and election date, and board seats available is displayed by the user interface upon user selection of a director tab 1308. In FIG. 13D, current officer information 1309 including name, position, and elected date of each officer and number of current officers is displayed by the user interface upon user selection of an officers tab 1310.

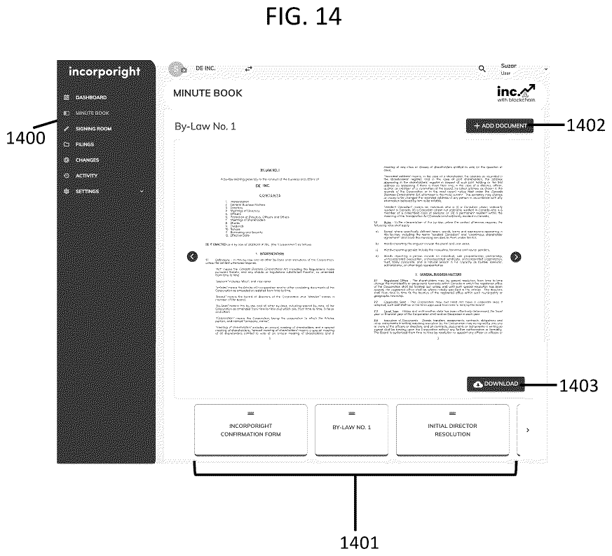

FIG. 14 illustrates an example of a user interface of the software application for a minute book module 1400 of the system including company records/documents 1401 that may be viewed within the minute book module 1400. The user interface includes methods by which the user provides input to the system designating an instruction to add a document 1402 to the minute book and download a document 1403 from the minute book.

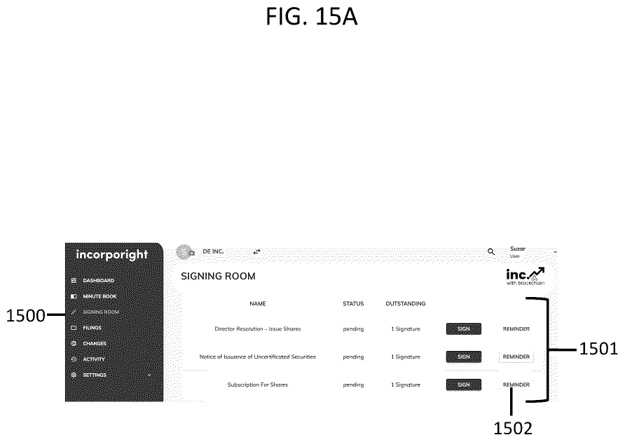

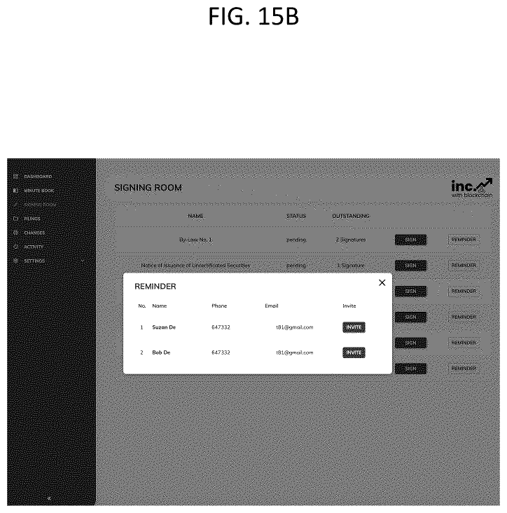

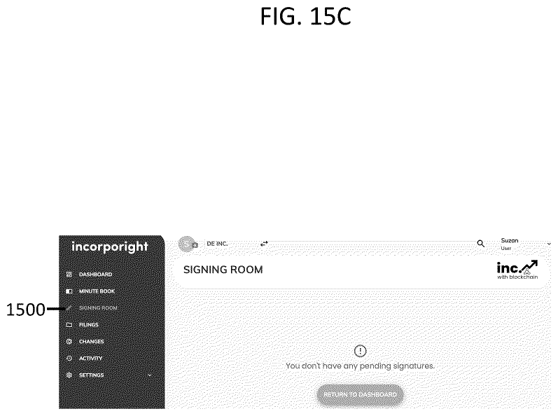

FIG. 15A illustrates an example of a user interface of the software application for a signing room module 1500 of the system. A list of corporate forms 1501 including their corresponding name, status, and number of outstanding signatures are displayed. Input may be provided to send a reminder 1502 to other parties to sign a particular form, as illustrated in FIG. 15B. In embodiments, parties are not required to have an account to sign and/or review forms. FIG. 15C illustrates the user interface when there are no forms requiring signature.

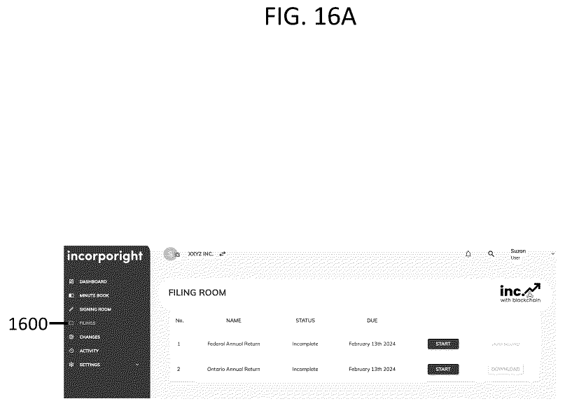

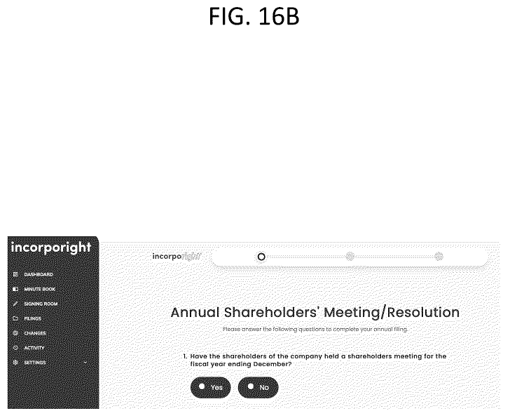

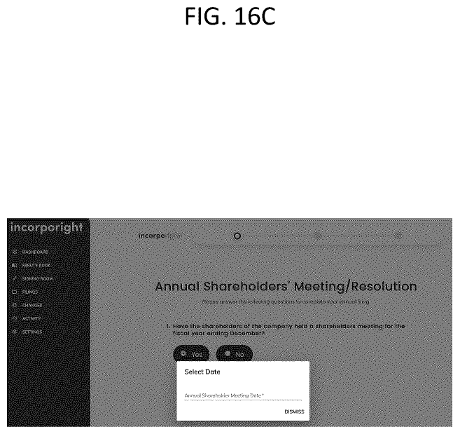

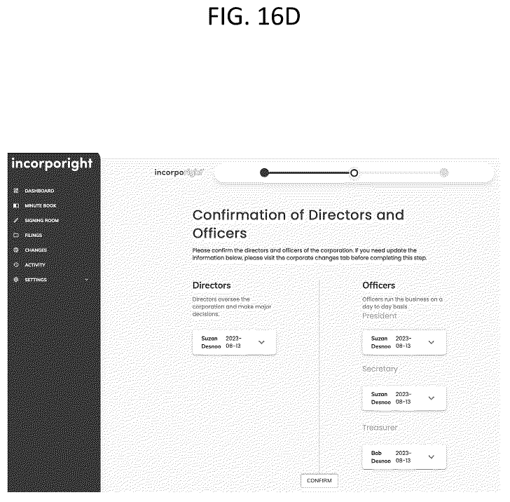

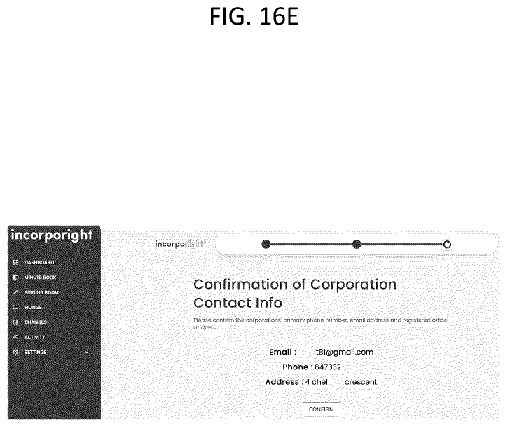

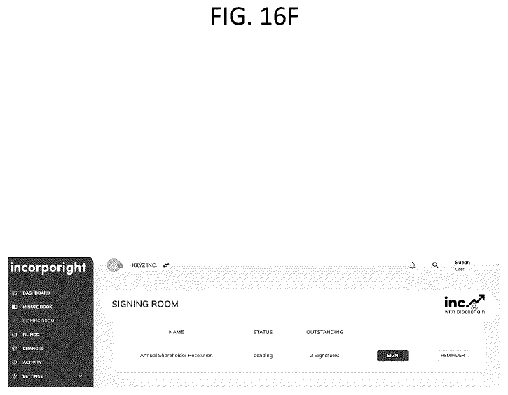

FIG. 16A illustrates an example of a user interface of the software application for a filing room module 1600 of the system including legal and regulatory documents. Name, status (incomplete or complete), and due date are displayed. The user interface of the of the software application includes methods by which the user provides input to the system designating an instruction to begin a corporate annual report, and an instruction to download a document. FIGS. 16B-16E illustrate the system requesting at least one user input via the user interface designating a confirmation of completion of shareholders meetings for the fiscal year end, a date of the meeting, a confirmation of the directors and officers, and a confirmation of corporation contact information. The system is configured to generate an annual shareholder resolution that may be signed by users via the signing room module, as illustrated in FIG. 16F. The system autonomously transmits the corporate annual return or the corporate annual return is manually transmitted by a user to a government body.

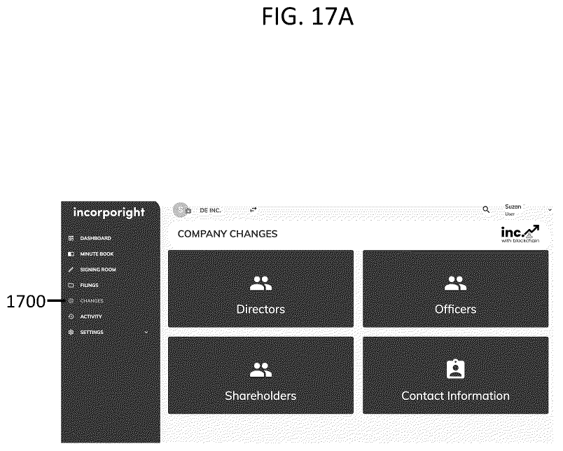

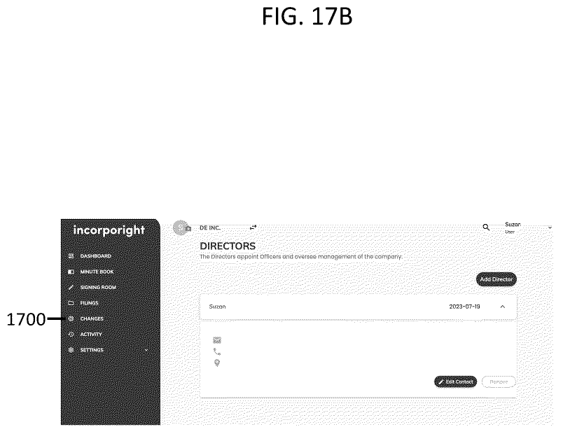

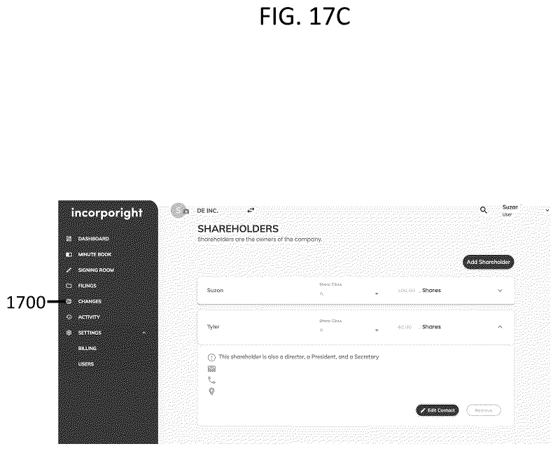

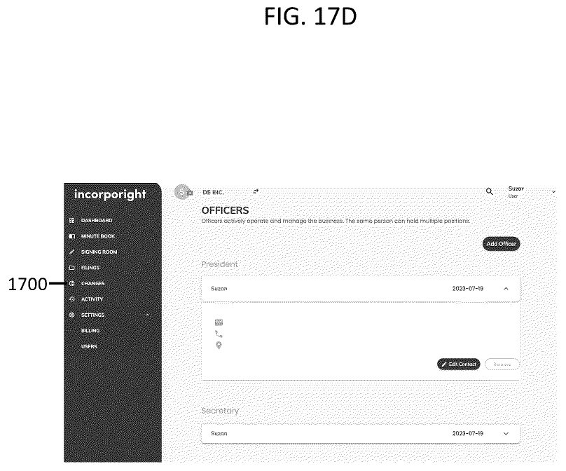

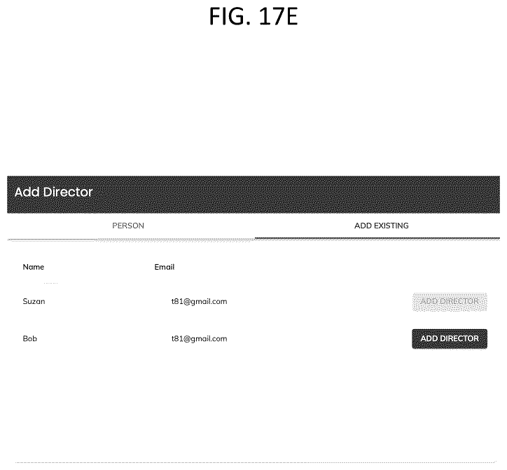

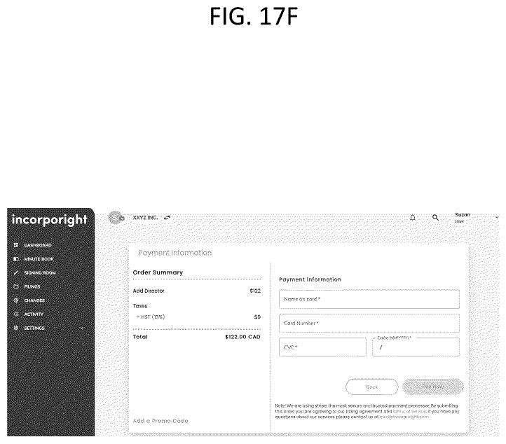

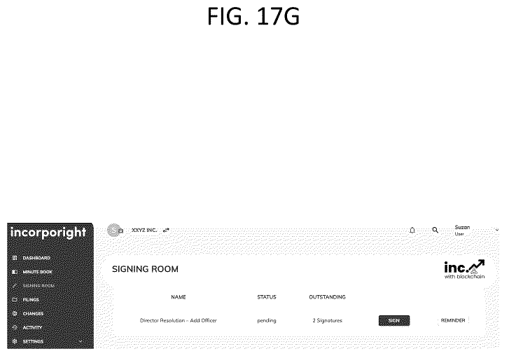

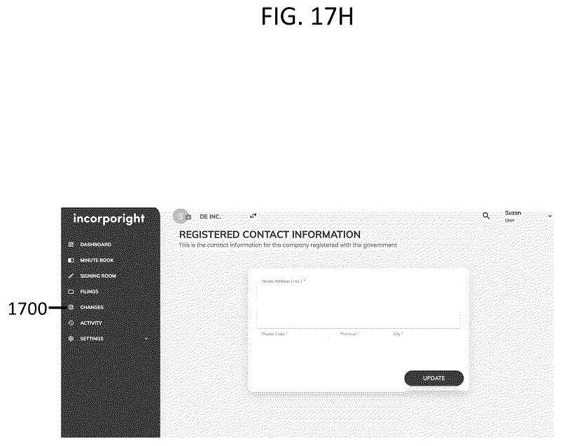

FIG. 17A illustrates an example of a user interface of the software application for the company changes module 1700 of the system. The company changes module 1700 is used to make company changes to directors, officers, and shareholders, company contact information. In FIG. 17B, the user interface of the of the software application includes methods by which the user provides input to the system designating an addition of a director, a removal of a director, and a modification to director information. In FIG. 17C, the user interface of the software application includes methods by which the user provides input to the system designating an addition of a shareholder, a transfer of shares of a shareholder, a modification to shareholder information, a modification to the number of shares assigned to a shareholder. In FIG. 17D, the user interface of the software application includes methods by which the user provides input to the system designating an addition of an officer, a removal of an officer, or a modification to officer information and title. An addition, modification, or removal of a director, shareholder, or officer may be executed by the system once payment is provided for execution of the update and the requisite corporate resolution and other documents (if applicable) are signed accordingly using the signing module user interface. For instance, in FIG. 17E, the user interface of the software application includes methods by which the user provides input to the system designating personal information (e.g., name, address, citizenship, etc.) of a new director or an existing contact as the new director. In FIG. 17F, the user interface of the software application includes methods by which the user provides input to the system designating payment information. After paying, the system is configured to generate an updated director resolution for signing via the signing room module, as illustrated in FIG. 17G. In FIG. 17H the user interface of the software application includes methods by which the user provides input to the system designating an update to contact information of the corporation.

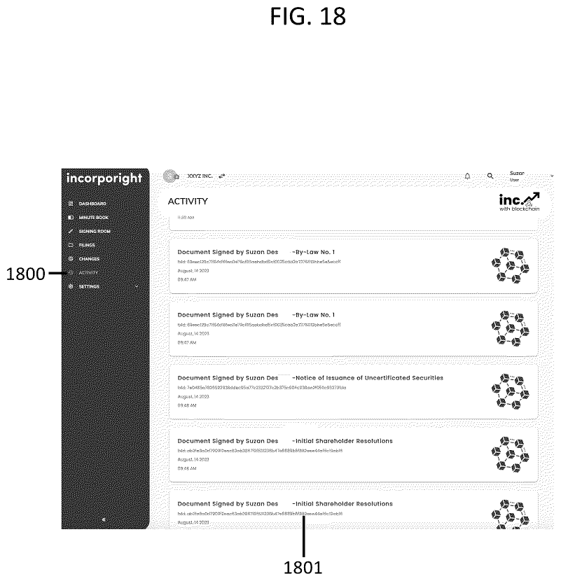

FIG. 18 illustrates an example of a user interface of the software application for an activity module 1800 of the system wherein a record of all corporate actions performed (e.g., new shares issues or signature of particular document) and the corresponding blockchain transaction ID 1801 and date and time during which each action was performed are displayed.

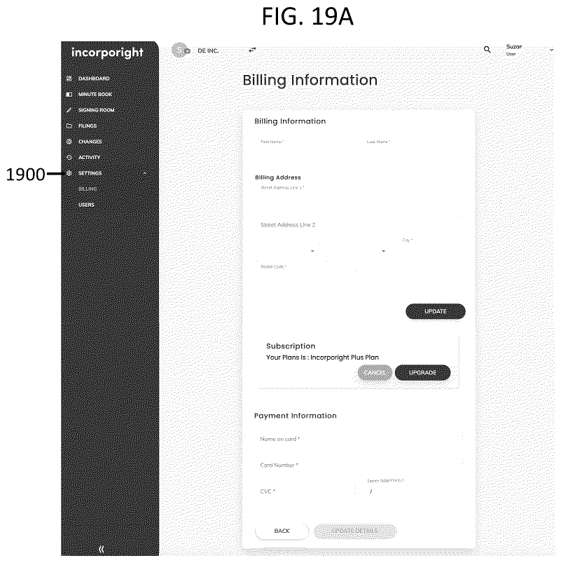

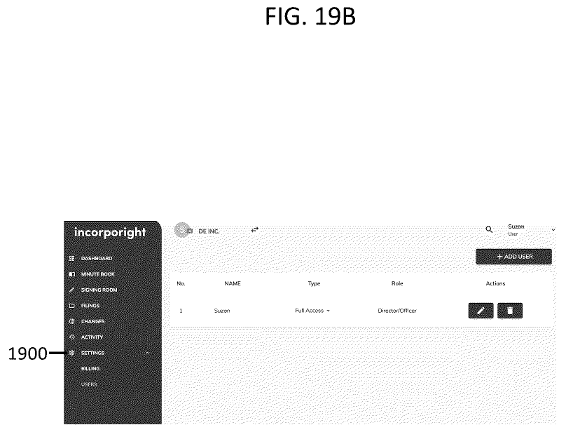

FIG. 19A illustrates an example of a user interface of the software application for a settings module 1900 of the system. In FIG. 19A, the user interface of the software application includes methods by which the user provides input to the system designating billing information including name and address, payment information, and an instruction to change or cancel a subscription plan. In FIG. 19B, the user interface of the software application includes methods by which the user provides input to the system designating an addition of a user information including name, accessibility, and role, a deletion of a user, and a modification to a user.

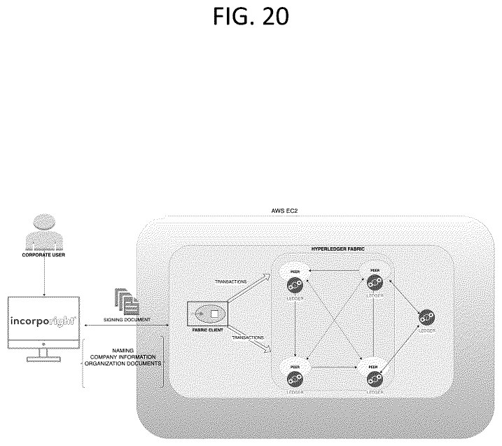

FIG. 20 illustrates a diagram of a Hyperledger Fabric blockchain network 100 integrated with the system. Information 101 provided as input to the system via the software application 102 from a user 103 and generated by the system are provided to the blockchain network 100 as transaction requests 104. The blockchain network 100 approves or rejects the transaction requests after checking details required to authenticate the transactions 104. Each peer node 105 performs a particular function, such as validating transactions, maintaining the ledger, and executing chaincode. Approved transactions 104 are recorded in blocks and are transmitted to peer nodes 105. Each of the peer nodes 105 update their local ledger 106 with the block such that the transactions 104 are committed.

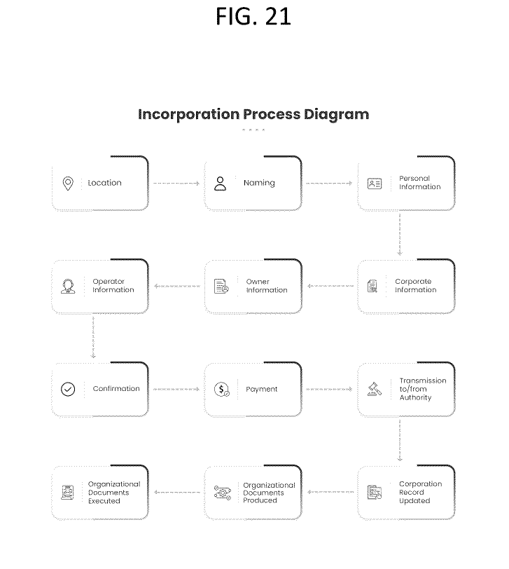

FIG. 21 illustrates a flowchart of a process for incorporation of a business including the system receiving at least one input via the user interface of the software application designating an address of the business; the system receiving at least one input via the user interface of the software application designating a proposed corporation name of the business; the system receiving at least one input via the user interface of the software application designating personal information; the system receiving at least one input via the user interface of the software application designating corporate information; the system receiving at least one input via the user interface of the software application designating owner information; the system receiving at least one input via the user interface of the software application designating operator information; the system generating and displaying, via the user interface, a confirmation of incorporation details form; the system receiving at least one input via the user interface of the software application designating payment information and processing a payment; the system transmitting an application for incorporation to an authority body for approval; the system updating a profile of the organization within the software application and corporate-specific information stored in a database; the system generating corporate organizational documents; and the system receiving at least one input via the user interface of the software application designating a signature on one or more corporate organizational documents. Further details of each step of the process are described above. In different embodiments the order of steps may vary, steps may be added, and/or steps may be deleted.

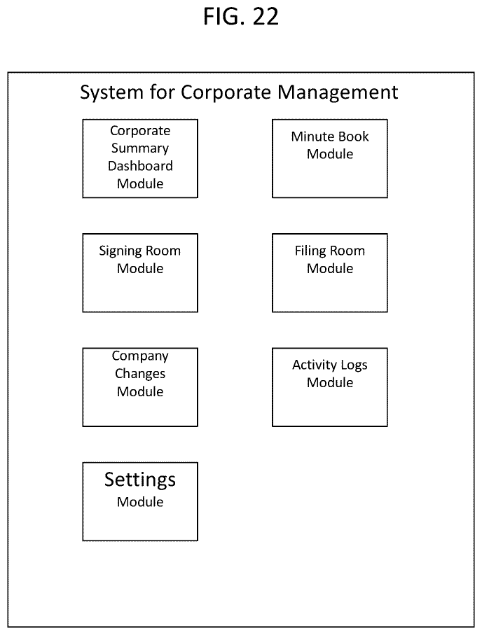

FIG. 22 illustrates an example of the system for corporate management of a corporation including a corporate summary dashboard module, a minute book module, a signing room module, a filings module, a company changes module, an activity logs module, and a settings module.

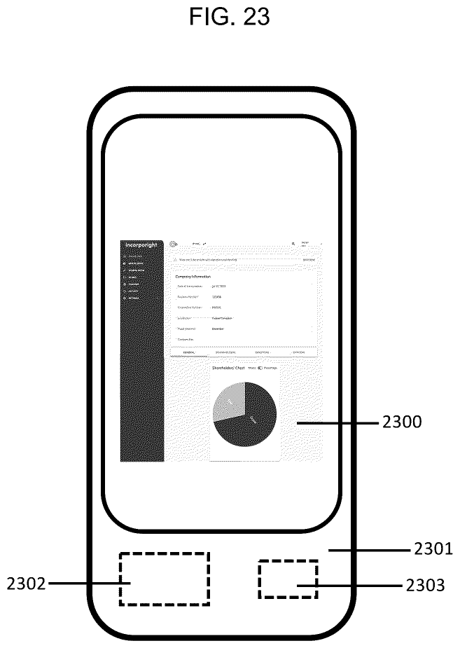

FIG. 23 illustrates an example of a user interface 2300 of a software application executed by a communication device 2301. FIG. 23 also illustrates internal components of the communication device 2301, including at least a processor 2302 and a memory 2303.

In embodiments, transmissions and storage are encrypted.

Some embodiments may be implemented as a system, a method, or a computer program product. As such, aspects of the invention may take the form of a hardware embodiment, a software embodiment, or an embodiment combining software and hardware aspects. Some embodiments may take the form of a computer program embodied in a computer readable media including computer readable program code. Some embodiments may take the form of a non-transitory, machine-readable medium storing instructions that when executed by a processor effectuates operations performed by the system as described herein.

Various embodiments of the invention have been described in detail. Since changes in and or additions to the above-described best mode may be made without departing from the nature, spirit or scope of the invention, the invention is not to be limited to those details.

1. A method for incorporating a business, comprising:
receiving, by a system for incorporating a business, via a user interface of a software application of a communication device, at least one first input designating a business location;
receiving, by the system, via the user interface of the software application, at least one second input designating a proposed corporation name;
receiving, by the system, via the user interface of the software application, at least one third input designating personal details of a user, an industry, and sole owner and operator or joint owners or operators, wherein upon designating joint owners or operators, the at least one third input further comprises owner information of each owner, ownership stake of each owner, and operator information of each operator;
transmitting, by the system or an administrator, at least one of the personal details of the user, the industry, the owner information of each owner, the ownership stake of each owner, and the operator information of each operator to a third-party authority;
generating, by the system, via the software application, corporate organizational documents based on at least one of the at least first input, the at least second input, and the at least third input;
updating, by the system, at least a profile account of the business based on at least one of the at least first input, the at least second input, the at least third input, and at least one of the corporate organizational documents;
receiving, by the system, via the user interface of the software application, at least one fourth input designating a signature on at least one of the corporate organizational documents;
updating, by the system, via the software application, an auditable and unalterable ledger based on at least some data received and data generated by the system using a blockchain framework integrated within the system;
storing, by the system, via the software application, at least some of the data received and the data generated by the system on a blockchain network using the blockchain framework integrated within the system;
monitoring, by the system, via the software application, the ledger using the blockchain framework integrated within the system; and
controlling, by the system, via the software application, user access to parts of the system using the blockchain framework integrated within the system;
wherein the software application comprises program code configured to execute operations of the system.

2. The method of claim 1, further comprising:
determining, by the system, via the software application, whether there are any conflicts between the proposed corporation name and existing corporation names and whether the proposed corporation name is inappropriate or improper according to applicable legislation; and
displaying, by the system, via the user interface of the software application, a notification relating to the proposed corporation name, wherein the possible notifications include a notification that the proposed corporation name satisfies a preliminary name check, is similar to one or more existing corporation names, is an exact match to an existing corporation name, and is inappropriate or improper according to applicable legislation.

3. The method of claim 1, further comprising:
generating, by the system, a confirmation of incorporation details form based on the at least one first input, the at least one second input, and the at least one third input;
displaying, by the system, via the user interface of the software application, the confirmation of incorporation details form; and
receiving, by the system, via the user interface of the software application, at least one fifth input designating a confirmation of the incorporation details displayed.

4. The method of claim 1, further comprising:
managing, by the system, via the software application, the corporation using a corporate summary dashboard module, a minute book module, a signing room module, a filings module, a company changes module, an activity log module, and a settings module.

5. The method of claim 4, further comprising:
displaying, by the system, within the corporate summary dashboard module of the system, via the user interface of the software application, company information, shareholder information, director information, and officer information;
displaying, by the system, within the minute book module of the system, via the user interface of the software application, the corporate organizational documents;
receiving, by the system, within the minute book module of the system, via the user interface of the software application, at least one sixth input designating an instruction to download a document within the minute book module and an instruction to add a new document to the minute book module;
displaying, by the system, within the signing module of the system, via the user interface of the software application, a name of documents requiring review or signature, a status of each document, and the documents requiring review or signature, wherein the at least one fourth input designating the signature on at least one of the corporation documents is received within the signing module of the system, via the user interface of the software application;
displaying, by the system, within the filings module, via the user interface of the software application, at least one corporate annual return, a state of each corporate annual return, and a due date of each corporate annual return;
receiving, by the system, within the filings module, via the user interface of the software application, at least one seventh input designating an instruction to start a corporate annual return, upon which, the system receives, within the filings module, via the user interface of the software application, at least one eighth user input designating a confirmation of completion of shareholders meetings for the fiscal year end, a date of the meeting, a confirmation of directors and officers, and a confirmation of corporation contact information;
generating, by the system, within the filings module, via the software application, an annual resolution based on at least one of the at least one eighth input and information stored in a database;
filing, by the system, within the filings module, via the software application, at least one of the corporation documents or another document with an external third party authority;
obtaining, by the system, within the filings module, via the software application, a document from the external third party authority;
receiving, by the system, within the company changes module, via the user interface of the software application, at least one ninth input designating a new director, a modification to existing director information, or a removal of an existing director; a new share issuance, a modification to existing shareholder information, or a transfer or redemption of shares of an existing shareholder; and a new officer, a modification to existing officer information, or a removal of an existing officer;
displaying, by the system, within the activity logs module, via the user interface of the software application, a list of all actions performed relating to the corporation and a blockchain transaction ID corresponding to each action; and
receiving, by the system, within the settings module, via the user interface of the software application, at least one tenth input designating a modification to billing information; and
management of users comprising adding a new user, a modification to an existing user, or a deletion of an existing user and assigning a role and access level.

6. The method of claim 1, further comprising:
receiving, by the system, via the user interface of the software application, at least one eleventh input designating an instruction to begin an incorporation process.

7. The method of claim 1, further comprising:
displaying, by the system, via the user interface of the software application, a location within a map corresponding with the business location.

8. The method of claim 1, wherein the at least one third input further comprises a payment plan and billing and payment information.

9. The method of claim 1, wherein the blockchain framework supports smart contracts to automate and execute predefined actions comprising at least one of dividend distributions, voting procedures, compliance tracking, and automated contract performance based on predefined rules.

10. The method of claim 1, further comprising:
receiving, by the system, via the user interface of the software application, at least one twelfth input designating a class of shares, priority rights of the shares, non-voting or voting rights of the shares, unlimited or limited shares, a number of authorized shares, a redeemable condition of the shares, a retractable condition of the shares, and dividend rights of the shares.

11. The method of claim 1, wherein:
the system is configured to manage a plurality of corporations using a single user account; and
the method further comprises:
receiving, by the system, via the user interface of the software application, at least one thirteenth input designating a corporation from the plurality of corporations to manage using the system.

12. A non-transitory, machine-readable media storing program code of a software application that when executed by a processor effectuates system operations comprising:
receiving, by the system, via a user interface of the software application of a communication device, at least one first input designating a business location;
receiving, by the system, via the user interface of the software application, at least one second input designating a proposed corporation name;
receiving, by the system, via the user interface of the software application, at least one third input designating personal details of a user, an industry, and sole owner and operator or joint owners or operators, wherein upon designating joint owners or operators, the at least one third input further comprises owner information of each owner, ownership stake of each owner, and operator information of each operator;
transmitting, by the system or an administrator, at least one of the personal details of the user, the industry, the owner information of each owner, the ownership stake of each owner, and the operator information of each operator to a third-party authority;
generating, by the system, via the software application, corporate organizational documents based on at least one of the at least first input, the at least second input, and the at least third input;
updating, by the system, at least a profile account of the business based on at least one of the at least first input, the at least second input, the at least third input, and at least one of the corporate organizational documents;
receiving, by the system, via the user interface of the software application, at least one fourth input designating a signature on at least one of the corporate organizational documents;
updating, by the system, via the software application, an auditable and unalterable ledger based on at least some data received and data generated by the system using a blockchain framework integrated within the system;
storing, by the system, via the software application, at least some of the data received and the data generated by the system on a blockchain network using the blockchain framework integrated within the system;
monitoring, by the system, via the software application, the ledger using the blockchain framework integrated within the system; and
controlling, by the system, via the software application, user access to parts of the system using the blockchain framework integrated within the system.

13. The media of claim 12, wherein the operations further comprise:
determining, by the system, via the software application, whether there are any conflicts between the proposed corporation name and existing corporation names and whether the proposed corporation name is inappropriate or improper according to applicable legislation; and
displaying, by the system, via the user interface of the software application, a notification relating to the proposed corporation name, wherein the possible notifications include a notification that the proposed corporation name satisfies a preliminary name check, is similar to one or more existing corporation names, is an exact match to an existing corporation name, and is inappropriate or improper according to applicable legislation.

14. The media of claim 12, wherein the operations further comprise:
generating, by the system, a confirmation of incorporation details form based on the at least one first input, the at least one second input, and the at least one third input;
displaying, by the system, via the user interface of the software application, the confirmation of incorporation details form; and
receiving, by the system, via the user interface of the software application, at least one fifth input designating a confirmation of the incorporation details displayed.

15. The media of claim 12, wherein the operations further comprise:
managing, by the system, via the software application, the corporation using a corporate summary dashboard module, a minute book module, a signing room module, a filings module, a company changes module, an activity log module, and a settings module.

16. The media of claim 15, wherein the operations further comprise:
displaying, by the system, within the corporate summary dashboard module of the system, via the user interface of the software application, company information, shareholder information, director information, and officer information;
displaying, by the system, within the minute book module of the system, via the user interface of the software application, the corporate organizational documents;
receiving, by the system, within the minute book module of the system, via the user interface of the software application, at least one sixth input designating an instruction to download a document within the minute book module and an instruction to add a new document to the minute book module;
displaying, by the system, within the signing module of the system, via the user interface of the software application, a name of documents requiring review or signature, a status of each document, and the documents requiring review or signature, wherein the at least one fourth input designating the signature on at least one of the corporation documents is received within the signing module of the system, via the user interface of the software application;
displaying, by the system, within the filings module, via the user interface of the software application, at least one corporate annual return, a state of each corporate annual return, and a due date of each corporate annual return;
receiving, by the system, within the filings module, via the user interface of the software application at least one seventh, input designating an instruction to start a corporate annual return, upon which, the system receives, within the filings module, via the user interface of the software application, at least one eighth user input designating a confirmation of completion of shareholders meetings for the fiscal year end, a date of the meeting, a confirmation of directors and officers, and a confirmation of corporation contact information;
generating, by the system, within the filings module, via the software application, an annual resolution based on at least one of the at least one eighth input and information stored in a database;
filing, by the system, within the filings module, via the software application, at least one of the corporation documents or another document with an external third party authority;
obtaining, by the system, within the filings module, via the software application, a document from the external third party authority;
receiving, by the system, within the company changes module, via the user interface of the software application, at least one ninth input designating a new director, a modification to existing director information, or a removal of an existing director; a new share issuance, a modification to existing shareholder information, or a transfer or redemption of shares of an existing shareholder; and a new officer, a modification to existing officer information, or a removal of an existing officer;
displaying, by the system, within the activity logs module, via the user interface of the software application, a list of all actions performed relating to the corporation and a blockchain transaction ID corresponding to each action; and
receiving, by the system, within the settings module, via the user interface of the software application, at least one tenth input designating a modification to billing information; and
management of users comprising adding a new user, a modification to an existing user, or a deletion of an existing user and assigning a role and access level.

17. The media of claim 12, wherein at least one of:
the operations further comprise:
receiving, by the system, via the user interface of the software application, at least one eleventh input designating an instruction to begin an incorporation process;
the operations further comprise:
displaying, by the system, via the user interface of the software application, a location within a map corresponding with the business location;
the at least one third input further comprises a payment plan and billing and payment information; and
the blockchain framework supports smart contracts to automate and execute predefined actions comprising at least one of dividend distributions, voting procedures, compliance tracking, and automated contract performance based on predefined rules.

18. The media of claim 12, the operations further comprise:
receiving, by the system, via the user interface of the software application, at least one twelfth input designating a class of shares, priority rights of the shares, non-voting or voting rights of the shares, unlimited or limited shares, a number of authorized shares, a redeemable condition of the shares, a retractable condition of the shares, and dividend rights of the shares.

19. The media of claim 12, wherein:
the system is configured to manage a plurality of corporations using a single user account; and
the operations further comprise:
receiving, by the system, via the user interface of the software application, at least one thirteenth input designating a corporation from the plurality of corporations to manage using the system.

20. A method for managing a corporation, comprising:
managing, by a system, via a software application, the corporation using a corporate summary dashboard module, a minute book module, a signing room module, a filings module, a company changes module, an activity log module, and a settings module;
displaying, by the system, within the corporate summary dashboard module of the system, via the user interface of the software application, company information, shareholder information, director information, and officer information;
displaying, by the system, within the minute book module of the system, via the user interface of the software application, corporate documents;
receiving, by the system, within the minute book module of the system, via the user interface of the software application, at least one first input designating an instruction to download a document within the minute book module and an instruction to add a new document to the minute book module;
displaying, by the system, within the signing module of the system, via the user interface of the software application, a name of documents requiring review or signature, a status of each document, and the documents requiring review or signature;
receiving, by the system, within the signing module of the system, via the user interface of the software application, at least one second input designating a signature on at least one document;
displaying, by the system, within the filings module, via the user interface of the software application, at least one corporate annual return, a state of each corporate annual return, and a due date of each corporate annual return;
receiving, by the system, within the filings module, via the user interface of the software application, at least one third input designating an instruction to start a corporate annual return, upon which, the system receives, within the filings module, via the user interface of the software application, at least one fourth user input designating a confirmation of completion of shareholders meetings for the fiscal year end, a date of the meeting, a confirmation of directors and officers, and a confirmation of corporation contact information;
generating, by the system, within the filings module, via the software application, an annual resolution based on at least one of the at least one fourth input and information stored in a database;
filing, by the system, within the filings module, via the software application, at least one document with an external third party authority;
obtaining, by the system, within the filings module, via the software application, a document from the external third party authority;
receiving, by the system, within the company changes module, via the user interface of the software application, at least one fifth input designating a new director, a modification to existing director information, or a removal of an existing director; a new share issuance, a modification to existing shareholder information, or a transfer or redemption of shares of an existing shareholder; and a new officer, a modification to existing officer information, or a removal of an existing officer;
displaying, by the system, within the activity logs module, via the user interface of the software application, a list of all actions performed relating to the corporation and a blockchain transaction ID corresponding to each action;
receiving, by the system, within the settings module, via the user interface of the software application, at least one sixth input designating a modification to billing information; and
management of users comprising adding a new user, a modification to an existing user, or a deletion of an existing user and assigning a role and access level;
updating, by the system, via the software application, an auditable and unalterable ledger based on at least some data received and data generated by the system using a blockchain framework integrated within the system;
storing, by the system, via the software application, at least some of the data received and the data generated by the system on a blockchain network using the blockchain framework integrated within the system;
monitoring, by the system, via the software application, the ledger using the blockchain framework integrated within the system; and
controlling, by the system, via the software application, user access to parts of the system using the blockchain framework integrated within the system.
